(19) United States
(12) Patent Application Publication
(10) Pub. No.: US 2016/0041708 A1
(43) Pub. Date: Feb. 11, 2016

(54) TECHNIQUES FOR ORGANIZING INFORMATION ON A COMPUTING DEVICE USING MOVABLE OBJECTS

(71) Applicant: MICROSOFT TECHNOLOGY LICENSING, LLC, Redmond, WA (US)

(72) Inventors: Gregory G. Class, Redmond, WA (US); Eliot J. Graff, Redmond, WA (US); Connie Missimer, Redmond, WA (US); Julie A. Guinn, Redmond, WA (US); Sumit Basu, Redmond, WA (US)

(73) Assignee: MICROSOFT TECHNOLOGY LICENSING, LLC, Redmond, WA (US)

(21) Appl. No.: 14/886,540

(22) Filed: Oct. 19, 2015

Related U.S. Application Data
(63) Continuation of application No. 12/340,187, filed on Dec. 19, 2008, now abandoned.

(51) Int. Cl. G06F 3/0482; G06F 3/0484; G06F 3/0481

(52) U.S. Cl. CPC G06F 3/0482; G06F 3/04812; G06F 3/04842; G06F 3/04845

(57) ABSTRACT

Techniques to organize information on a computing device using movable objects are described. A computer system may include a display operative to present a graphical user interface with a pointer to select one or more movable objects and position the movable objects at various target positions on the graphical user interface, an input device operative to receive selected movable objects and user movement to position the selected movable objects at a target position on the graphical user interface, and an object position component operative to anchor the selected movable objects at the target position using an anchor element to form a group of anchored objects, and arrange the group of anchored objects in a visual pattern relative to the anchor element. Other embodiments are described and claimed.

### CROSS-REFERENCE TO RELATED APPLICATIONS

The application is a continuation of, claims the benefit of and priority to, previously filed U.S. patent application Ser. No. 12/340,187 entitled “Techniques for Organizing Information on a Computing Device Using Movable Objects” filed on Dec. 19, 2008, the subject matter of which is hereby incorporated by reference in its entirety.

### BACKGROUND

A graphical user interface typically organizes information on a screen in a predetermined manner. For example, a user can typically choose whether objects on a screen are displayed as individual items on the screen, a list, tiles, and so forth. These choices, however, are typically limited to the templates provided by the graphical user interface. Furthermore, they do not provide explicit mechanisms for grouping and organizing information. As a result, they do not necessarily reflect preferences for how a human operator would organize and present information outside of the provided templates. It is with respect to these and other considerations that the present improvements are provided.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments are generally directed to techniques for organizing information for presentation on a graphical user interface (GUI) and for storage of the associated organizational metadata. Some embodiments are particularly directed to techniques for allowing an operator to arrange and organize objects on the GUI in a free-form and intuitive manner, thereby improving how the operator consumes information.

In one embodiment, for example, a computer system may comprise a display operative to present a GUI with a pointer to select one or more movable objects and position the movable objects at various target positions on the GUI. The computer system may also comprise an input device operative to receive selected movable objects and user movement to position the selected movable objects at a target position on the GUI. The computer system may further comprise an object position component operative to anchor the selected movable objects at the target position using an anchor element to form a group of anchored objects, and arrange the group of anchored objects in a visual pattern relative to the anchor element. Other embodiments are described and claimed.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

FIG. 1 illustrates one embodiment of a computer system.

FIGS. 2A-D illustrate various embodiments of graphical user interfaces.

FIGS. 3A-D illustrate various embodiments of graphical user interfaces.

FIG. 4 illustrates one embodiment of a logic flow.

FIG. 5 illustrates one embodiment of a computing system architecture.

### DETAILED DESCRIPTION

Various embodiments are generally directed to techniques for organizing information for presentation on a GUI. Some embodiments are particularly directed to techniques for allowing an operator to arrange and organize objects on the GUI in a free-form manner. The techniques may be used to create groups of movable objects, and implicitly or explicitly associate other objects with these groups. This solution enables a user to take an unorganized collection of objects and visually arrange them into object categories, groups or groups. For instance, the collection of objects is transformed into a visual metaphor for the collection as a desktop with the collection of objects represented as a group of note cards. An original group with a larger number of multiple objects is arranged into multiple groups with a smaller number of one or more objects. The operator may then pin or anchor the objects together, and cause the anchored objects to be presented in various visual patterns around the anchor. The anchored groups effectively create groups of movable objects that can be classified, moved, or rearranged before saving the categories for various applications. Once a group has been formed, other objects may be explicitly or implicitly associated with the group. As a result, the operator can group and organize separate objects into groups, groups or categories in a virtual space in a manner that is similar to how the operator might group or organize objects in a physical space. Consequently, the operator may group, organize and present information in more intuitive and desired manner.

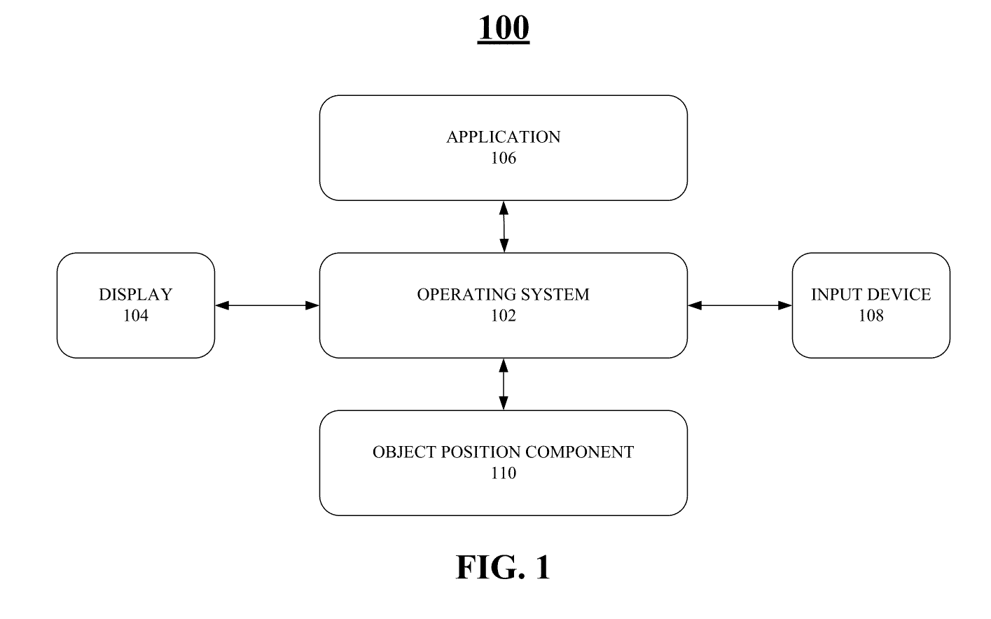

FIG. 1 illustrates an exemplary computer system 100 suitable for implementing techniques for organizing and presenting information on a GUI according to one or more embodiments. The computer system 100 may be implemented, for example, as various devices including, but not limited to, a personal computer (PC), server-based computer, laptop computer, notebook computer, tablet PC, handheld computer, personal digital assistant (PDA), mobile telephone, combination mobile telephone/PDA, television device, set top box (STB), consumer electronics (CE) device, any other suitable computing or processing system which is consistent with the described embodiments.

As illustrated, the computer system 100 is depicted as a block diagram comprising several functional components or modules which may be implemented as hardware, software, or any combination thereof, as desired for a given set of design parameters or performance constraints. Although FIG. 1 may show a limited number of functional components or modules for ease of illustration, it can be appreciated that additional functional components and modules may be employed for a given implementation.

As used herein, the terms “component” and “system” are intended to refer to a computer-related entity, either hardware, a combination of hardware and software, software, or software in execution. For example, a component can be implemented as a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers as desired for a given implementation.

Various embodiments may be described in the general context of computer-executable instructions, such as program modules or components, being executed by a computer. Generally, program modules or components include any software element arranged to perform particular operations or implement particular abstract data types. Some embodiments also may be practiced in distributed computing environments where operations are performed by one or more remote processing devices that are linked through a communications network. In a distributed computing environment, program modules or components may be located in both local and remote computer storage media including memory storage devices.

As shown in FIG. 1, the computer system 100 may comprise an operating system 102 coupled to a computer display 104, an application 106, an input device 108, and an object position module 110. The operating system 102 may be arranged to control the general operation of the computer system 100 and may be implemented, for example, by a general-purpose operating system such as a MICROSOFT® operating system, UNIX® operating system, LINUX® operating system, or any other suitable operating system which is consistent with the described embodiments.

The computer display 104 may any electronic display arranged to present content to a user and may be implemented by any type of suitable visual interface or display device. Examples of the computer display 104 may include a computer screen, computer monitor, liquid crystal display (LCD), flat panel display (FPD), cathode ray tube (CRT), and so forth.

The computer system 100 may be configured to execute various computer programs such as application 106. In one or more embodiments, the application 106 may be may be implemented as a desktop publishing application, graphical design application, presentation application, chart application, spreadsheet application, or word processing application. In various implementations, the application 106 may comprise an application program forming part of a Microsoft Office suite of application programs. Examples of such application programs include Microsoft Office Publisher, Microsoft Office Visio, Microsoft Office PowerPoint, Microsoft Office Excel, Microsoft Office Access, and Microsoft Office Word. In some cases, application programs can be used as stand-alone applications, but also can operate in conjunction with server-side applications, such as a Microsoft Exchange server, to provide enhanced functions for multiple users in an organization. Although particular examples of the application 106 have been provided, it can be appreciated that the application 106 may be implemented by any other suitable application which is consistent with the described embodiments.

The input device 108 may be arranged to receive input from a user of a computer system 100. In one or more embodiments, the input device 108 may be arranged to allow a user to select and move objects within a GUI presented on the computer display 102. In such embodiments, the input device 108 may be implemented as a mouse, trackball, touch pad, stylus, tablet PC pen, touch screen, and so forth.

In one or more embodiments, the application 106 may be arranged to present a GUI on the computer display 104. The GUI may be used, for example, as an interface to display various views of an electronic document, web page, template, and so forth, and receive operator selections or commands. During the authoring process, an operator, author or user may interact with the GUI to manipulate various graphics to achieve a desired arrangement. In some implementations, the GUI may be subsequently printed and/or published by the user after completion of the authoring process.

The system 100 may include the object position module 110. The object position module 110 provides an application and GUI interface to categorize or sort items of information (or objects) in a way that resembles sticky notes on a bulletin board, note cards on a desk, photos on a table, or other physical metaphors of arrangeable items. The user may then move the sticky notes, note cards, or other movable objects to a position on the virtual board and affixes an anchoring element in a graphic such as a pin, nail, paperweight, title box, or other element that is a metaphor for an anchor to the group. The user can then explicitly associate items with this anchor. Alternative, the user clicks a button, waits for a certain time duration, or performs some other action that signifies that the user is done arranging and categorizing the movable objects. After the object position module 110 triggers a condition indicating that the elements are categorized, the categorical elements fan out, square off, or in some other way arrange themselves around the anchor element. Once the elements are anchored, they can be moved to another group or can be repositioned by intuitively dragging the elements around close to the anchor, spinning the elements around the anchor, exploding the elements out around the anchor on hover, clicking on one element and then clicking on another group, or by using some other aesthetically pleasing or useful effect.

The object position module 110 may be implemented, for example, by a set of event-driven routines to operate as a stand-alone application program, or enhance the application 106. In various implementations, the operating system 102 may be arranged to monitor user movement received from the input device 108 and to execute various computer programs and event-driven routines such as application 106 and object position module 110. In some cases, the object position module 110 may be built into the operating system 102 and/or the application 106.

In various embodiments, the object position module 110 may be generally implemented to create, edit, sort, search, arrange and categorize information for affinity diagramming sessions or other information sorting tasks. Affinity diagramming may refer to sorting data into logical groups based on some commonalities between data. The object position module 110 may implement these operations utilizing a GUI and movable objects presented on the GUI.

The GUI may display various GUI elements such as graphics to a user including a pointer to select and manipulate a movable object. The movable object generally may comprise any two-dimensional or three-dimensional image capable of being selected and moved within the GUI. Examples of movable objects may include without limitation notes, messages, icons, symbols, documents, images, pictures, text, shape, and any other discrete set of information. The movable object may be moved using a “click and drag” technique where the pointer is positioned over the object, a mouse click selects the object, and the selected object is moved within the GUI to a new location. The movable object may also be moved by other control techniques, such as selecting and using keyboard commands to move the movable object. The embodiments are not limited in this context.

The movable object may take any shape, size or dimensions representative of the type of information it represents. For example, when the movable object represents a note item, the movable object may be implemented as a square or rectangular bounding box. The note item may include information displayed within the boundaries of the bounding box. The bounding box may comprise, for example, multiple points on the boundary of the bounding box, or points in-between the boundaries. By way of example and not limitation, the bounding box may include nine points (four points if the items are rectangular) including the four vertices and four midpoints of the boundary and the center of the object. The nine points of the rectangular bounding box may be used individually to determine the position of the object, to make movement calculations, for calculating overlap with a target position, to anchor the movable object with other objects, and so forth. It can be appreciated that when moving an object, the pointer may be placed at various positions on the object. As such, the pointer location may be too unpredictable to be used as a reference. Accordingly, using the points of the bounding box may result in more accurate positioning and calculations.

Additionally or alternatively, in some implementations, an optional guide (not shown) may be structured and arranged to assist users when aligning and positioning objects on a GUI. In one or more embodiments, the guide may comprise a plurality of collinear guide pixels and may be implemented, for example, by at least one of a guideline, a guide region, a shape guide, and a text baseline. The guide may comprise, for example, a horizontal and/or vertical guideline implemented as a ruler, margin, edge, gridline, and so forth. In some embodiments, the guide may comprise a two-dimensional guide region such as a shape outline or solid shape. The guide also may comprise a shape guide comprising a vertical or horizontal guideline extending from a corner or midpoint of an object. The shape guide may be used for alignment between objects and, in some implementations, may be displayed only when an edge or midpoint of a moving object is aligned with the edge or midpoint of another object. The guide may comprise a text baseline comprising a horizontal or vertical line upon which text sits and under which text letter descenders extend. A template comprising one or more configurable guides may be presented to a user. In some implementations, multiple templates comprising various arrangements of guides may be provided allowing a user to select one or more guides from one or more templates. Guides may be built into document templates to provide a user with contemporaneous guidance during the authoring process of a document even when not actively moving objects or using the objects of a template.

The object position component 110 may implement techniques for organizing information for presentation on a GUI. In particular, the object position component 110 may implement techniques for allowing an operator to arrange and organize objects on the GUI in a free-form manner. The operator may then pin the objects together, and cause the pinned objects to be presented in various visual patterns around the pin. As a result, the operator can group and organize separate objects into groups, groups or categories in a virtual space provided by the GUI in a manner that is similar to how the operator might group or organize objects in a physical space, such as on a note board, a desk, table, or other physical environment. Consequently, the operator may group, organize and present information in more intuitive and desired manner using natural human behavior and organizing principles.

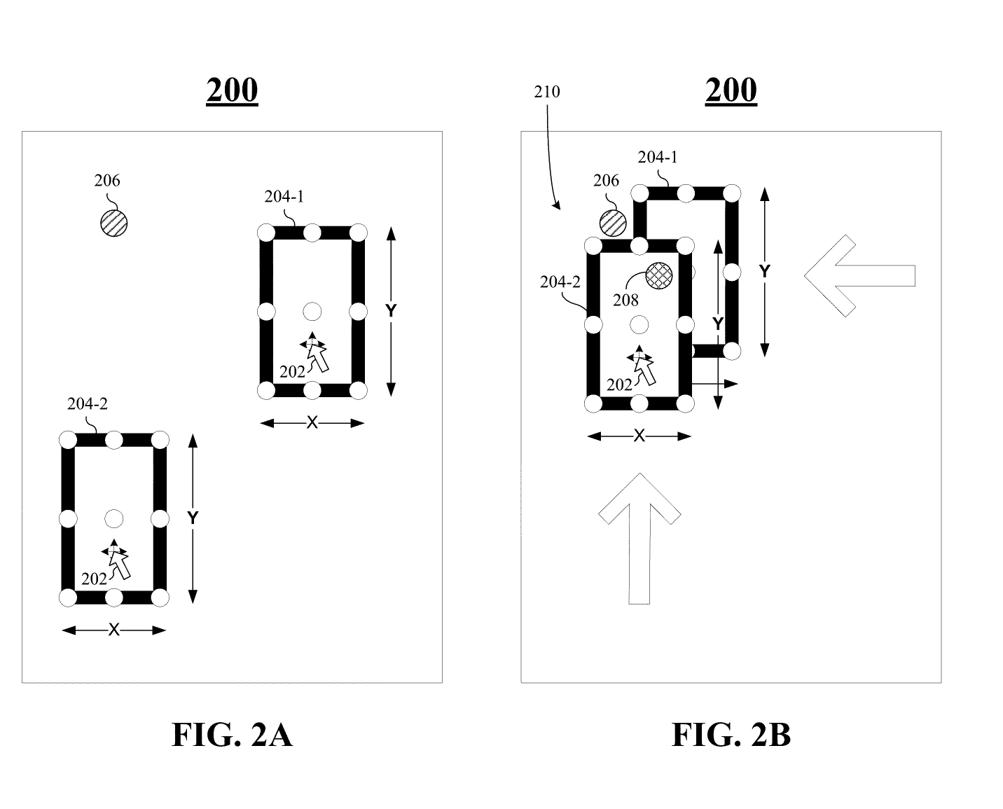

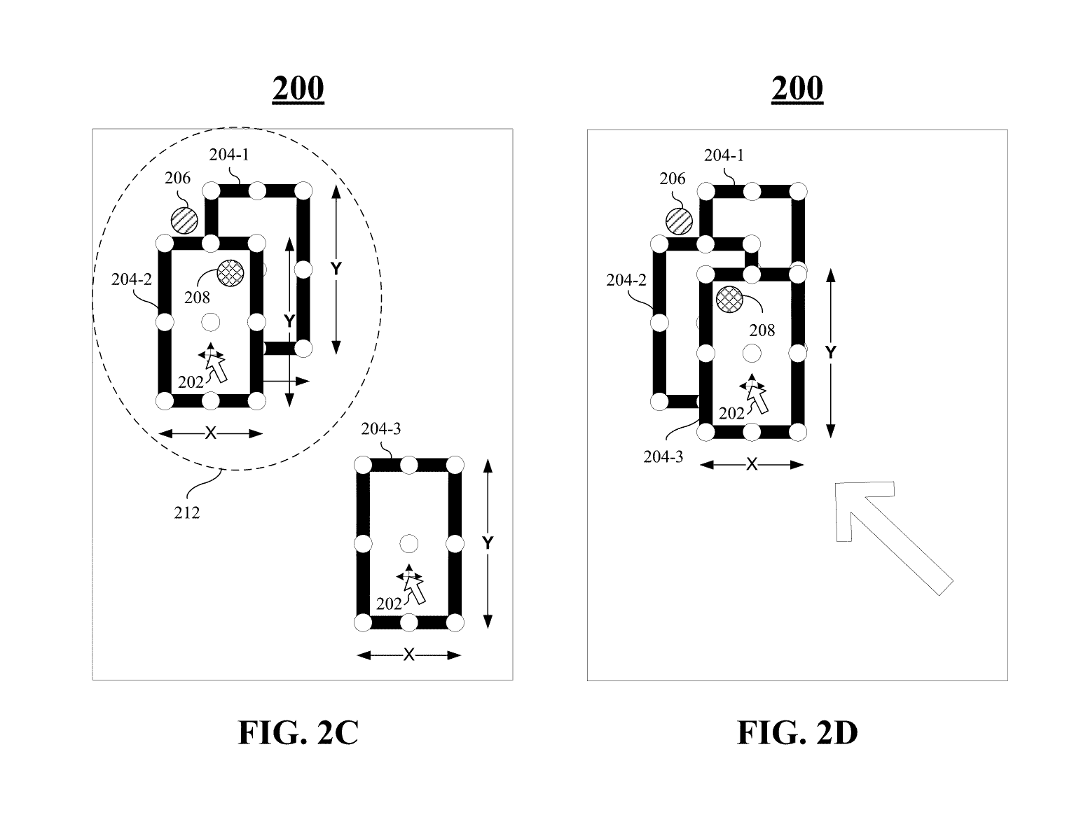

In one embodiment, the computer system 100 may comprise the display 104 operative to present a GUI (or GUI view) with a pointer to select one or more movable objects and position the movable objects at various target positions on the GUI. The computer system 100 may also comprise the input device 108 operative to receive selected movable objects and user movement to position the selected movable objects at a target position on the GUI. The computer system 100 may further comprise an object position component 110 operative to anchor the selected movable objects at the target position using an anchor element to form a group of anchored objects, and arrange the group of anchored objects in a visual pattern relative to the anchor element. Exemplary implementations for the computer system 100 in general, and the object position component 110 in particular, may be described in more detail with reference to FIGS. 2A-D and 3A-D.

FIGS. 2A-2D each illustrates an exemplary GUI 200. In various implementations, the GUI 200 may be presented on the display 104 of the computer system 100. As shown, the GUI 200 may comprise a pointer 202 to select one or more movable objects 204-1-m and move a selected movable object 204-1-m to a target position 206. The movable object 204-1-m may be represented as a rectangular bounding box comprising nine points including the four vertices and four midpoints of the boundary and the center of the movable object 204-1-m. Each of the nine points of the rectangular bounding box may be used individually to determine the position of the object 204 and to make movement calculations, as needed.

Referring to FIG. 2A, the movable objects 204-1, 204-2 are selected in turn by the pointer 202 and moved toward the target position 206 on the GUI 200. In this case, user movement received in the horizontal direction is translated into a standard horizontal object movement rate (X), and user movement received in the vertical direction is translated into a standard vertical object movement rate (Y). In some cases, the movement rates X, Y may be controlled as the movable objects 204-1, 204-2 approach the target position 206. For example, the movement rates X, Y may be automatically decreased (or translated) from the movement rate X, Y provided by the input device 108 (from a user) to a slower rate as they approach the target position 206 to improve placement accuracy on the target position 206.

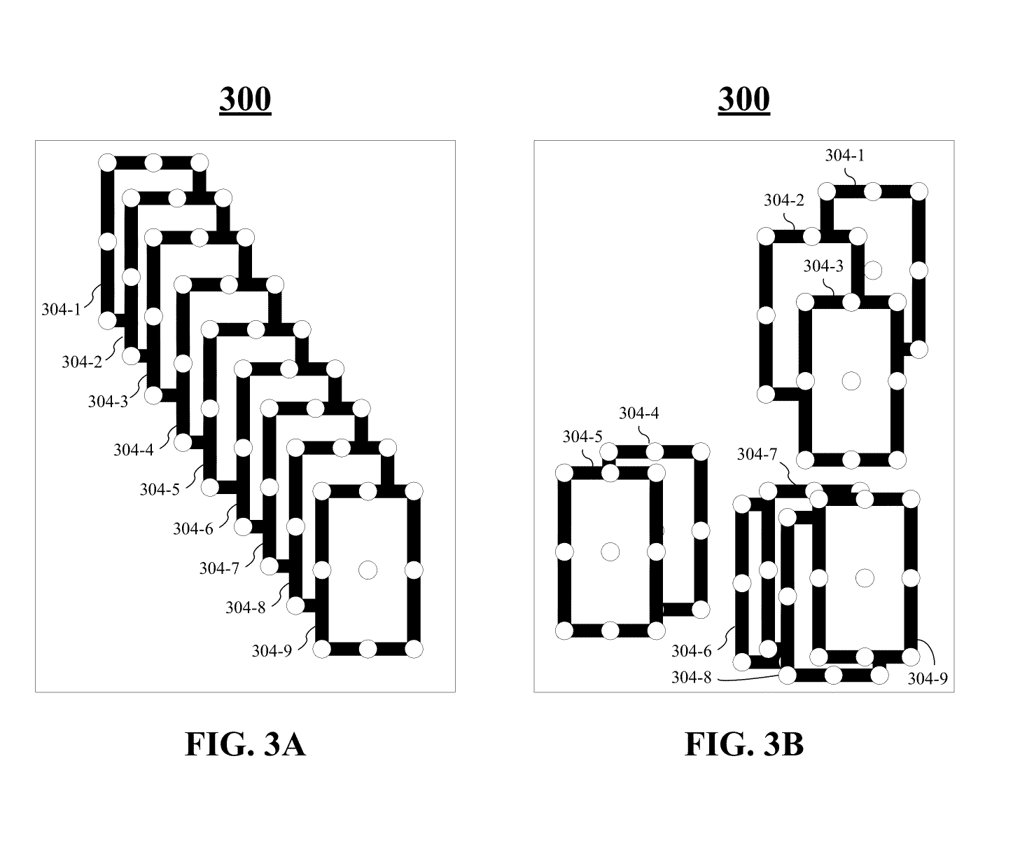

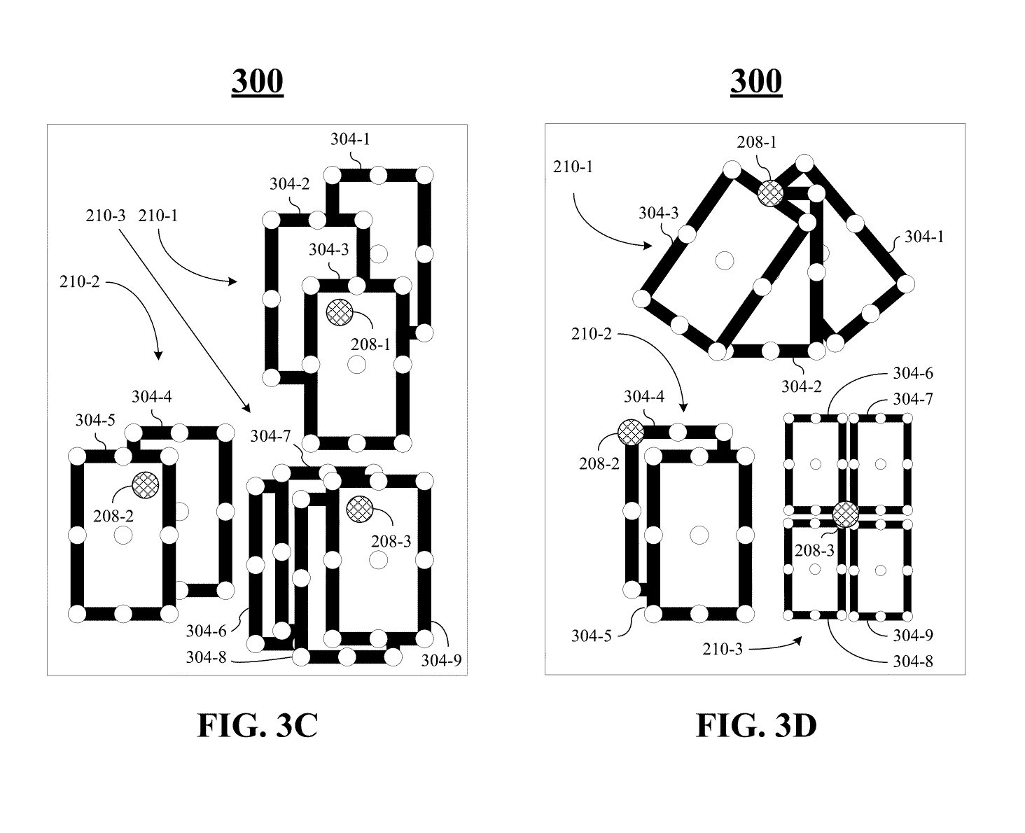

Referring to FIG. 2B, the movable objects 204-1, 204-2 have been moved one or near the target location 206. At this point, the object position component 110 may be used to anchor the selected movable objects 204-1, 204-2 at the target position 206 using an anchor element 208 to form a group of anchored objects 210. The group of anchored objects 210 may then be arranged in a visual pattern relative to the anchor element 208, as further described with reference to FIGS. 3A-3D.

Referring to FIG. 2C, the input device 108 may be used to select a movable object 204-3. The input device 108 may receive the selected movable object 204-3 and user movement to position the selected movable object 204-3 in spatial proximity 212 to an anchor element, such as the anchor element 208 used for the group of anchored objects 210. The spatial proximity 212 for a given target position 206 may be a user-configurable distance, or set using a default distance.

Referring to FIG. 2D, when the selected movable object 204-3 is within spatial proximity 212 of the target position 206 and/or the anchor element 208, the object position component 110 may then automatically anchor or “snap” the selected movable object 204-3 at the target position 206 using the anchor element 208. In this way, new movable objects 204 may be easily added to the existing group of anchored objects 210.

In some cases, the selected movable object 204-3 may be brought in spatial proximity 212 of more than one existing groups of anchored elements 208. In one embodiment, for example, the input device 108 may be operative to receive the selected movable object 204-3 and user movement to position the selected movable object 204-3 in spatial proximity to multiple anchor elements 208, and the object position component 110 may be operative to select one of the multiple anchor elements 208 in accordance with a set of anchoring rules, and automatically anchor the selected movable object 204-3 using the selected anchor element. The anchoring rules may be user-configurable rules, such as snapping to the closest anchor element, or default rules.

FIGS. 3A-3D each illustrates an exemplary GUI 300. In various implementations, the GUI 300 may be presented on the display 104 of the computer system 100. The GUI 300 may be used to describe categorizing and arranging operations for the object position component 110.

Referring to FIG. 3A, the GUI 300 may present a stack of multiple movable objects 304-1-n that are waiting to be categorized. For instance, the movable objects 304-1 to 304-9 may comprise note items or memos for a personal information manager (PIM), such as Microsoft® Office Outlook®, Microsoft Office OneNote®, or some other productivity application. When implemented as note items or memos, the movable objects 304-1 to 304-9 may include multimedia information presented on some or all of the movable objects 304-1 to 304-9, and a viewer may view some or all of the multimedia information based on where a movable object is with respect to other movable objects (e.g., above, below, full overlap, partial overlap, size, etc.).

Referring to FIG. 3B, the movable objects 304-1 to 304-9 are selected in turn by the pointer 202 and moved towards various target positions 206-1-r on the GUI 300 to form multiple unanchored groups of movable objects. In the illustrated embodiment shown in FIG. 3B, the movable objects 304-1, 304-2 and 304-3 may be placed in a target position 206-1 located at a top-right corner of the GUI 300, the movable objects 304-4, 304-5 may be placed in a target position 206-2 located at a bottom-left corner of the GUI 300, and the movable objects 304-6, 304-7, 304-8 and 304-9 may be placed in a target position 206-3 located at a bottom-right corner of the GUI 300. The target positions 206-1-r may be anywhere on the surface of GUI 300, and the movable objects 304-1 to 304-9 may be categorized into any number of groups having any number of movable objects in each group.

Referring to FIG. 3C, once the movable objects 304-1 to 304-9 have been moved to the corresponding target locations 206-1-r, the object position component 110 may be used to anchor the selected movable objects 304-1 to 304-9 using various anchor elements 208-1-s to form various anchored objects 210-1-t. In the illustrated embodiment shown in FIG. 3C, the selected movable objects 304-1 to 304-3 at the target position 206-1 using an anchor element 208-1 to form a group of anchored objects 210-1. Similarly, the object position component 110 may be used to anchor the selected movable objects 304-4, 304-5 at the target position 206-2 using an anchor element 208-2 to form a group of anchored objects 210-2. Finally, the object position component 110 may be used to anchor the selected movable objects 304-6 to 304-9 at the target position 206-3 using an anchor element 208-3 to form a group of anchored objects 210-3. The object position component 110 may anchor the various groups of selected movable objects 304-1 to 304-9 to form the groups of anchored objects 210-1 to 210-3 using various trigger conditions, such as an explicit command such as an anchor selection from a user, an implicit command such as hovering the pointer 202 over an unanchored group for a defined period of time, and so forth.

Referring to FIG. 3D, the various groups of anchored objects 210-1, 210-2 and/or 210-3 may then be arranged in a visual pattern relative to the anchor elements 208-1, 208-2 and/or 208-3. The visual patterns may comprise any type of visual pattern that is aesthetically desirable for a user and presents information contained by the movable objects 304-1-n in a manner that is viewable by a user or operator. For instance, the object position component 110 may be operative to arrange the anchored objects from the group of anchored objects 310-1 in a fan visual pattern, the anchored objects from the group of anchored objects 310-2 in a cascade visual pattern, the anchored objects from the group of anchored objects 310-3 in a grid visual pattern, and so forth. It may be appreciated that the exemplary visual patterns shown in FIG. 3D are merely by way of example and not limitation, and any type of desired visual pattern may be used for a given implementation. The embodiments are not limited in this context.

In addition to arranging the anchored objects 310-1 to 310-3 in various visual patterns, the object position component 110 may use various visual, audible and tactile effects to allow a viewer to differentiate between the various groups of anchored objects. For instance, the object position component 110 may form multiple groups of anchored objects, and assign different colors, different sounds, different vibrations or other visual/audible/tactile effects to each of the multiple groups of anchored objects. Furthermore, the object position component 110 may also change a size for a movable object or group of movable objects based on available display area on the display 104 (e.g., mobile screen, laptop screen, desktop screen, television, etc.), or other movable objects or groups of movable objects already on the display 104, and so forth. Referring again to the group of anchored objects 210-3, for example, the graphic items used to represent individual movable objects 304-6, 304-7, 304-8 and 304-9 may be reduced in size to fit in the remaining display area not consumed by the groups of anchored objects 210-1, 210-2. Similarly, one or all of the movable objects 304-1-n or groups of anchored objects 210-1-t may be sized to fit as different displays 104 are used (e.g., mobile phone versus desktop). The embodiments are not limited in this context.

Various other features, operations and functionality may be added to the object position component 110 for given implementations. Some of these features may be provided below with respect to the general categories of data connections, collaboration, and organizing information. The embodiments are not limited to these categories.

In various embodiments, the object position component 110 may be implemented to organize information using graphical items with rich connection to data. By way of example, the object position component 110 may provide or allow note pads used as note templates, structured data to be placed on both the front and back of a note with tools to rotate or flip individual notes to view the structured data, custom connections to data schemas, automatic schema discovery, custom schema creation, flexible reading/writing to a file, database or web service, and other customizable features. The embodiments are not limited in this context.

In various embodiments, the object position component 110 may be implemented to facilitate collaboration between operators. By way of example, the object position component 110 may provide or allow shared sessions to allow multiple people editing a same group of data, animations for real-time or near real-time edits, using multiple machines or one machine by many, connections from different devices (e.g., phone, laptop, desktop, etc.), use of multiple devices with different capabilities, storage of intermediate states, recording and playback of sorting sessions, placing markers or tags or “watch” status on specific notes to trace or follow subsequent use or operations, and so forth. The embodiments are not limited in this context.

In various embodiments, the object position component 110 may allow explicit grouping operations. By way of example, the object position component 110 may provide or allow different types of pins or anchors, placements near or on a pin, metaphors for collections, different viewing patterns (e.g., cascade, fans, grid, nesting, etc.), manipulating notes (e.g., push, pull, move, etc.), zooming notes from a group, creating and using a stick pad, exploding or reducing notes, presenting rich multimedia with a movable object (e.g., photo, sound, ink, font, video, etc.), note tools (e.g., search, select, group, reorganize, etc.), infinite canvas/pan/zoom features, different textures/colors/visual effects for movable objects, viewable/audible/tactile effects when moving a pointer across a movable object or groups of movable objects, viewing tools to view movable objects or groups of movable objects, management tools to manage movable objects or groups of movable objects, and so forth. The embodiments are not limited in this context.

Operations for various embodiments may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more elements of the computing system 100 or alternative elements as desired for a given set of design and performance constraints.

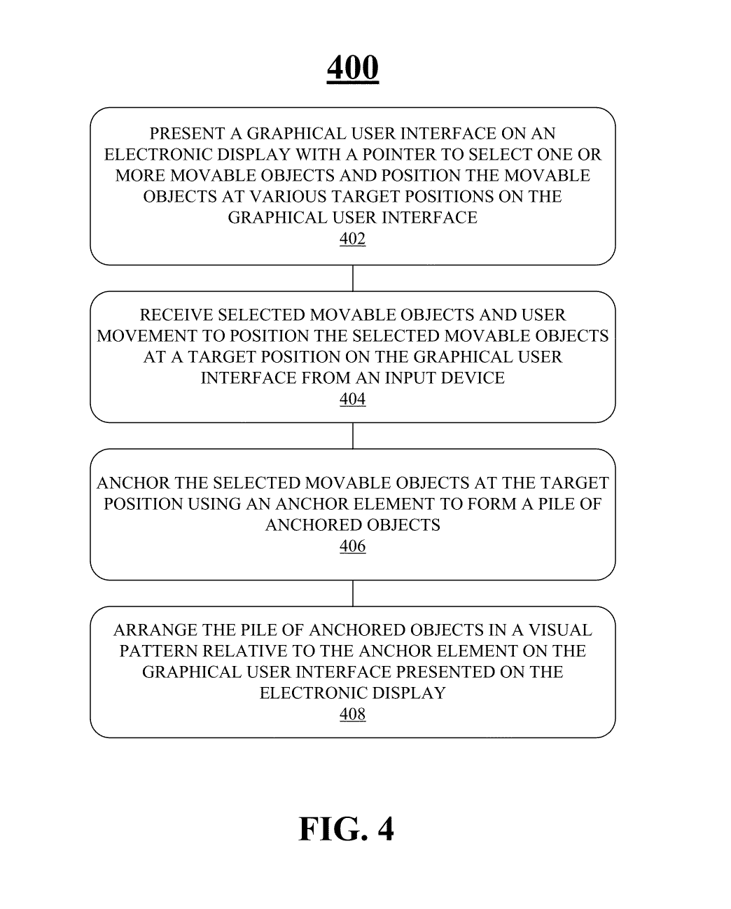

FIG. 4 illustrates one embodiment of a logic flow 400. The logic flow 400 may be representative of some or all of the operations executed by one or more embodiments described herein.

The logic flow 400 may present a graphical user interface on an electronic display with a pointer to select one or more movable objects and position the movable objects at various target positions on the graphical user interface. For example, the object position component 110 may present the GUIs 200, 300 on an electronic display 104 with the pointer 202 to select one or more movable objects 204-1-m, 304-1-n and position the movable objects 202 at various target positions 206-1-r on the GUIs 200, 300. The embodiments are not limited in this context.

The logic flow 400 may receive selected movable objects and user movement to position the selected movable objects at a target position on the graphical user interface. For example, the input device 108 may receive selected movable objects 204-1-m, 304-1-n and user movement to position the selected movable objects 204-1-m, 304-1-n at a target position 206-1-r on the GUIs 200, 300. The embodiments are not limited in this context.

The logic flow 400 may anchor the selected movable objects at the target position using an anchor element to form a group of anchored objects. For example, the object position component 110 may anchor the selected movable objects 204-1-m, 304-1-n at the target position 206-1-r using anchor element 208-1-s to form a group of anchored objects 210-1-t on the GUIs 200, 300. The embodiments are not limited in this context.

The logic flow 400 may arrange the group of anchored objects in a visual pattern relative to the anchor element on the graphical user interface presented on the electronic display. For example, the object position component 110 may arrange the group of anchored objects 210-1-t in a visual pattern relative to the anchor elements 208-1-s on the GUIs 200, 300 presented on the electronic display 104. The embodiments are not limited in this context.

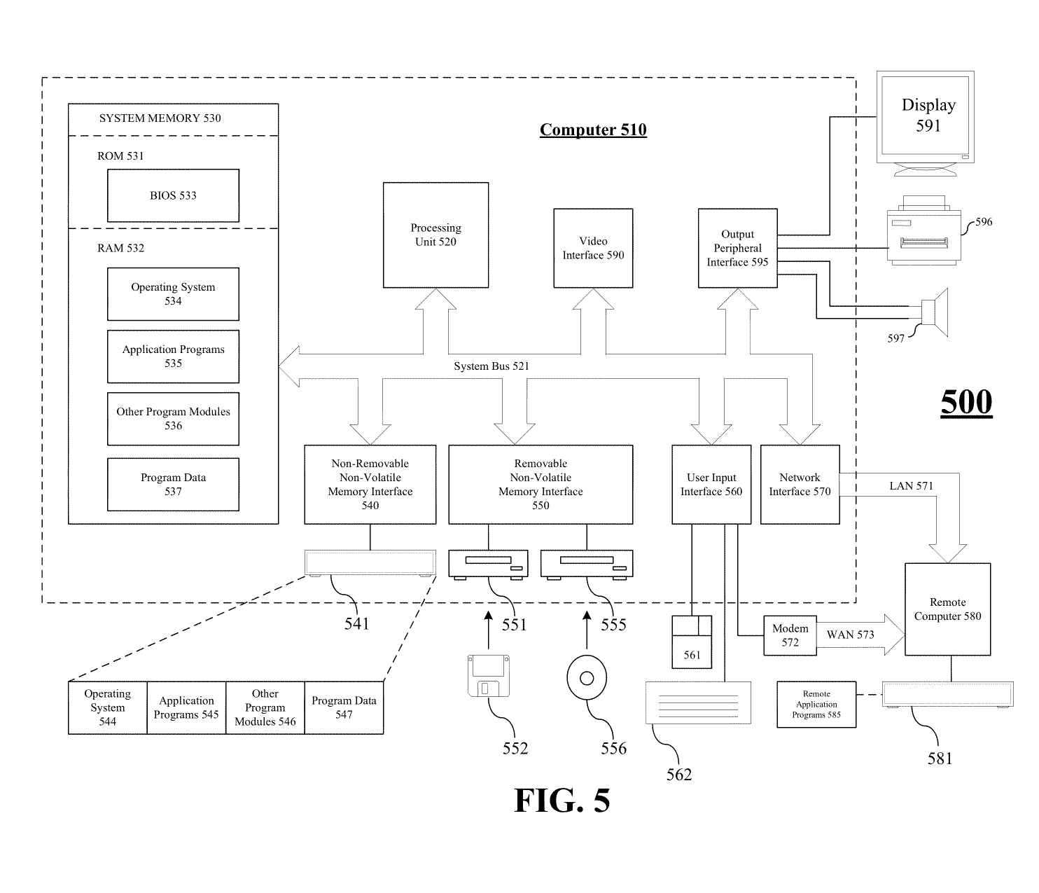

FIG. 5 illustrates a computing system architecture 500 suitable for implementing various embodiments, including the various elements of the computer system 100. It may be appreciated that the computing system architecture 500 is only one example of a suitable computing environment and is not intended to suggest any limitation as to the scope of use or functionality of the embodiments. Neither should the computing system architecture 500 be interpreted as having any dependency or requirement relating to any one or combination of components illustrated in the exemplary computing system architecture 500.

As shown in FIG. 5, the computing system architecture 500 includes a general purpose computing device such as a computer 510. The computer 510 may include various components typically found in a computer or processing system. Some illustrative components of computer 510 may include, but are not limited to, a processing unit 520 and a system memory unit 530.

In one embodiment, for example, the computer 510 may include one or more processing units 520. A processing unit 520 may comprise any hardware element or software element arranged to process information or data. Some examples of the processing unit 520 may include, without limitation, a complex instruction set computer (CISC) microprocessor, a reduced instruction set computing (RISC) microprocessor, a very long instruction word (VLIW) microprocessor, a processor implementing a combination of instruction sets, or other processor device. In one embodiment, for example, the processing unit 520 may be implemented as a general purpose processor. Alternatively, the processing unit 520 may be implemented as a dedicated processor, such as a controller, microcontroller, embedded processor, a digital signal processor (DSP), a network processor, a media processor, an input/output (I/O) processor, a media access control (MAC) processor, a radio baseband processor, a field programmable gate array (FPGA), a programmable logic device (PLD), an application specific integrated circuit (ASIC), and so forth. The embodiments are not limited in this context.

In one embodiment, for example, the computer 510 may include one or more system memory units 530 coupled to the processing unit 520. A system memory unit 530 may be any hardware element arranged to store information or data. Some examples of memory units may include, without limitation, random-access memory (RAM), dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), EEPROM, Compact Disk ROM (CD-ROM), Compact Disk Recordable (CD-R), Compact Disk Rewriteable (CD-RW), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk (e.g., floppy disk, hard drive, optical disk, magnetic disk, magneto-optical disk), or card (e.g., magnetic card, optical card), tape, cassette, or any other medium which can be used to store the desired information and which can be accessed by computer 510. The embodiments are not limited in this context.

In one embodiment, for example, the computer 510 may include a system bus 521 that couples various system components including the system memory unit 530 to the processing unit 520. A system bus 521 may be any of several types of bus structures including a memory bus or memory controller, a peripheral bus, and a local bus using any of a variety of bus architectures. By way of example, and not limitation, such architectures include an Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, and so forth. The embodiments are not limited in this context.

In various embodiments, the computer 510 may include various types of storage media. Storage media may represent any storage media capable of storing data or information, such as volatile or non-volatile memory, removable or non-removable memory, erasable or non-erasable memory, writeable or re-writeable memory, and so forth. Storage media may include two general types, including computer readable media or communication media. Computer readable media may include storage media adapted for reading and writing to a computing system, such as the computing system architecture 500. Examples of computer readable media for computing system architecture 500 may include, but are not limited to, volatile and/or nonvolatile memory such as ROM 531 and RAM 532. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio-frequency (RF) spectrum, infrared and other wireless media. Combinations of the any of the above should also be included within the scope of computer readable media.

In various embodiments, the system memory unit 530 includes computer storage media in the form of volatile and/or nonvolatile memory such as ROM 531 and RAM 532. A basic input/output system 533 (BIOS), containing the basic routines that help to transfer information between elements within computer 510, such as during start-up, is typically stored in ROM 531. RAM 532 typically contains data and/or program modules that are immediately accessible to and/or presently being operated on by processing unit 520. By way of example, and not limitation, FIG. 5 illustrates operating system 534, application programs 535, other program modules 536, and program data 537. Examples of application programs 535 may include the examples provided for the applications 106, and the object position component 110 as described with reference to FIGS. 1-4.

The computer 510 may also include other removable/non-removable, volatile/non-volatile computer storage media. By way of example only, FIG. 5 illustrates a hard disk drive 541 that reads from or writes to non-removable, non-volatile magnetic media, a magnetic disk drive 551 that reads from or writes to a removable, nonvolatile magnetic disk 552, and an optical disk drive 555 that reads from or writes to a removable, nonvolatile optical disk 556 such as a CD ROM or other optical media. The hard disk drive 541 is typically connected to the system bus 521 through a non-removable memory interface such as non-removable, non-volatile memory interface 540. The magnetic disk drive 551 and optical disk drive 555 are typically connected to the system bus 521 by a removable memory interface, such as removable, non-volatile memory interface 550. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media discussed above and illustrated in FIG. 5, provide storage of computer readable instructions, data structures, program modules and other data for the computer 510. In FIG. 5, for example, hard disk drive 541 is illustrated as storing operating system 544, application programs 545, other program modules 546, and program data 547. Note that these components can either be the same as or different from operating system 534, application programs 535, other program modules 536, and program data 537. Operating system 544, application programs 545, other program modules 546, and program data 547 are given different numbers here to illustrate that, at a minimum, they are different copies. A user may enter commands and information into the computer 510 through input devices such as a keyboard 562 and pointing device 561, commonly referred to as a mouse, trackball or touch pad. Other input devices (not shown) may include a microphone, joystick, game pad, satellite dish, scanner, or the like. These and other input devices are often connected to the processing unit 520 through a user input interface 560 that is coupled to the system bus 521, but may be connected by other interface and bus structures, such as a parallel port, game port or a universal serial bus (USB). A display 591 such as a monitor or other type of display device is also connected to the system bus 521 via an interface, such as a video interface 590. In addition to the display 591, computers may also include other peripheral output devices such as printer 596 and speakers 597, which may be connected through an output peripheral interface 595.

The computer 510 may operate in a networked environment using logical connections to one or more remote computers, such as a remote computer 580. The remote computer 580 may be a PC, a server, a router, a network PC, a peer device or other common network node, and typically includes many or all of the elements described above relative to the computer 510, although only a memory storage device 581 has been illustrated in FIG. 5 for clarity. The logical connections depicted in FIG. 5 include a local area network (LAN) 571 and a wide area network (WAN) 573, but may also include other networks. Such networking environments are commonplace in offices, enterprise-wide computer networks, intranets and the Internet.

When used in a LAN networking environment, the computer 510 is connected to the LAN 571 through a network interface 570 or adapter. When used in a WAN networking environment, the computer 510 typically includes a modem 572 or other technique suitable for establishing communications over the WAN 573, such as the Internet. The modem 572, which may be internal or external, may be connected to the system bus 521 via the user input interface 560, or other appropriate mechanism. In a networked environment, program modules depicted relative to the computer 510, or portions thereof, may be stored in the remote memory storage device. By way of example, and not limitation, FIG. 5 illustrates remote application programs 585 as residing on memory device 581. It will be appreciated that the network connections shown are exemplary and other techniques for establishing a communications link between the computers may be used. Further, the network connections may be implemented as wired or wireless connections. In the latter case, the computing system architecture 500 may be modified with various elements suitable for wireless communications, such as one or more antennas, transmitters, receivers, transceivers, radios, amplifiers, filters, communications interfaces, and other wireless elements. A wireless communication system communicates information or data over a wireless communication medium, such as one or more portions or bands of RF spectrum, for example. The embodiments are not limited in this context.

Various embodiments may be implemented using hardware elements, software elements, or a combination of both. Examples of hardware elements may include logic devices, microprocessors, circuits, circuit elements (e.g., transistors, resistors, capacitors, inductors, and so forth), integrated circuits, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

In some cases, various embodiments may be implemented as an article of manufacture. The article of manufacture may be implemented, for example, as a computer-readable storage medium storing logic and/or data for performing various operations of one or more embodiments. The computer-readable storage medium may include one or more types of storage media capable of storing data, including volatile memory or, non-volatile memory, removable or non-removable memory, erasable or non-erasable memory, writeable or re-writeable memory, and so forth. The computer-readable medium may store logic comprising instructions, data, and/or code that, if executed by a computer system, may cause the computer system to perform a method and/or operations in accordance with the described embodiments. Such a computer system may include, for example, any suitable computing platform, computing device, computer, processing platform, processing system, processor, or the like implemented using any suitable combination of hardware and/or software.

Various embodiments may comprise one or more elements. An element may comprise any structure arranged to perform certain operations. Each element may be implemented as hardware, software, or any combination thereof, as desired for a given set of design and/or performance constraints. Although an embodiment may be described with a limited number of elements in a certain topology by way of example, the embodiment may include more or less elements in alternate topologies as desired for a given implementation.

Although some embodiments may be illustrated and described as comprising exemplary functional components or modules performing various operations, it can be appreciated that such components or modules may be implemented by one or more hardware components, software components, and/or combination thereof. The functional components and/or modules may be implemented, for example, by logic (e.g., instructions, data, and/or code) to be executed by a logic device (e.g., processor). Such logic may be stored internally or externally to a logic device on one or more types of computer-readable storage media.

It also is to be appreciated that the described embodiments illustrate exemplary implementations, and that the functional components and/or modules may be implemented in various other ways which are consistent with the described embodiments. Furthermore, the operations performed by such components or modules may be combined and/or separated for a given implementation and may be performed by a greater number or fewer number of components or modules.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. It is worthy to note that although some embodiments may describe structures, events, logic or operations using the terms “first,” “second,” “third,” and so forth, such terms are used merely as labels, and are not intended to impose numerical requirements on their objects. Further, such terms are used to differentiate elements and not necessarily limit the structure, events, logic or operations for the elements.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method, comprising:
presenting a graphical user interface on an electronic display with a pointer to select one or more movable objects and position the movable objects at various target positions on the graphical user interface;
receiving selected movable objects and user movement to position the selected movable objects at a target position on the graphical user interface from an input device;
anchoring the selected movable objects at the target position using a visual anchor element selected by a user to form a group of anchored objects, wherein each anchored object in the group of anchored objects is anchored based on the visual anchor element, and wherein each anchored object in the group of anchored objects comprises a displayed bounding region; and
automatically arranging the group of anchored objects in a pattern relative to the anchor element on the graphical user interface presented on the electronic display in response to the anchoring.

2. The method of claim 1, comprising receiving a control directive to explicitly anchor a selected movable object to the group of anchored objects or another group of anchored objects.

3. The method of claim 1, comprising selecting one of multiple anchor elements in accordance with a set of anchoring rules when a selected movable object is in spatial proximity to the multiple anchor elements.

4. The method of claim 1, comprising automatically anchoring a selected movable object using an anchor element selected from multiple anchor elements when the selected movable object is in spatial proximity to the multiple anchor elements.

5. The method of claim 1, comprising arranging the anchored objects in a fan visual pattern, a cascade visual pattern or a grid visual pattern.

6. The method of claim 1, comprising assigning different colors, sounds or visual effects to different groups of anchored objects.

7. The method of claim 1 further comprising causing a two-dimensional guide region to display only when an edge or midpoint of a moving object is aligned with the edge or midpoint of another object.

8. An article of manufacture comprising a computer-readable storage memory storing instructions that when executed by a processor enable a computer system to:
present a graphical user interface on an electronic display with a pointer to select one or more movable objects and position the movable objects at various target positions on the graphical user interface;
receive selected movable objects and user movement to position the selected movable objects at a target position on the graphical user interface from an input device;
anchor the selected movable objects at the target position using a visual anchor element selected by a user to form a group of anchored objects, wherein each anchored object in the group of anchored objects is anchored based on the visual anchor element, and wherein each anchored object in the group of anchored objects comprises a displayed bounding region; and
automatically arrange the group of anchored objects in a pattern relative to the anchor element on the graphical user interface presented on the electronic display in response to the anchoring.

9. The article of manufacture of claim 7, further comprising instructions that when executed by a processor enable the computer system to receive a selected movable object and user movement to position the selected movable object in spatial proximity to an anchor element, and automatically anchor the selected movable object at the target position using the anchor element.

10. The article of manufacture of claim 7, further comprising instructions that when executed by a processor enable the computer system to receive a selected movable object and user movement to position the selected movable object in spatial proximity to multiple anchor elements, select one of the multiple anchor elements in accordance with a set of anchoring rules, and automatically anchor the selected movable object using the selected anchor element.

11. The article of manufacture of claim 7, further comprising instructions that when executed by a processor enable the computer system to arrange the anchored objects in a fan visual pattern, a cascade visual pattern or a grid visual pattern.

12. The article of manufacture of claim 7, further comprising instructions that when executed by a processor enable the computer system to form multiple groups of anchored objects.

13. The article of manufacture of claim 7, further comprising instructions that when executed by a processor enable the computer system to assign different colors, sounds or visual effects to different groups of anchored objects.

14. The article of manufacture of claim 7, further comprising instructions that when executed by a processor enable the computer system to form groups of movable objects prior to anchoring the groups of movable objects with respective anchor elements.

15. A computer system, comprising:
a display operative to present a graphical user interface with a pointer to select one or more movable objects and position the movable objects at various target positions on the graphical user interface;
an input device operative to receive selected movable objects and user movement to position the selected movable objects at a target position on the graphical user interface; and
an object position component operative to anchor the selected movable objects at the target position using a visual anchor element selected by a user to form a group of anchored objects, wherein each anchored object in the group of anchored objects is anchored based on the visual anchor element, and wherein each anchored object in the group of anchored objects comprises a displayed bounding region; and
wherein each anchored object in the group of anchored objects is anchored based on the single visual anchor element, at least two of the anchored objects representing different types of information, and automatically arrange the group of anchored objects in a visual pattern relative to the anchor element in response to the anchoring.

16. The computer system of claim 15, the input device operative to receive a selected movable object and user movement to position the selected movable object in spatial proximity to an anchor element, and the object position component operative to automatically anchor the selected movable object at the target position using the anchor element.

17. The computer system of claim 15, the input device operative to receive a selected movable object and user movement to position the selected movable object in spatial proximity to multiple anchor elements, and the object position component operative to select one of the multiple anchor elements in accordance with a set of anchoring rules, and automatically anchor the selected movable object using the selected anchor element.

18. The computer system of claim 15, the object position component operative to arrange the anchored objects in a fan visual pattern, a cascade visual pattern or a grid visual pattern.

19. The computer system of claim 15, the object position component operative to form multiple groups of anchored objects, and assign different colors, sounds or visual effects to each of the multiple groups of anchored objects.

20. The computer system of claim 15, wherein the displayed bounding box includes nine points, the nine points in positions comprising: four vertices of the bounding box, four midpoints of sides of the bounding box and a center of the anchored object.
